(19) United States
(12) Patent Application Publication
(10) Pub. No.: US 2015/0211996 A1
(43) Pub. Date: Jul. 30, 2015

(54) DROPLET QUANTITY DETERMINATION METHOD AND MEASURING DEVICE

(71) Applicant: Murata Manufacturing Co., Ltd., Nagaokakyo-shi (JP)

(72) Inventor: SEIJI KAMBA, Nagaokakyo-shi (JP)

(21) Appl. No.: 14/680,398

(22) Filed: Apr. 7, 2015

Related U.S. Application Data
(63) Continuation of application No. PCT/JP2013/075264, filed on Sep. 19, 2013.

(30) Foreign Application Priority Data
Nov. 13, 2012 (JP) 2012-249239

(51) Int. Cl. G01N 21/59; G01N 21/3581

(52) U.S. Cl. CPC G01N 21/59; G01N 21/3581; G01N 2201/12; G01N 2201/061

(57) ABSTRACT

A droplet quantity determination method that includes processes of holding a droplet on a first principal surface of an aperture-arranged structure, emitting electromagnetic waves to the droplet, and determining a quantity of the droplet based on a change in the electromagnetic waves due to the presence of the droplet.

### CROSS REFERENCE TO RELATED APPLICATIONS

The present application is a continuation of International application No. PCT/JP2013/075264, filed Sep. 19, 2013, which claims priority to Japanese Patent Application No. 2012-249239, filed Nov. 13, 2012, the entire contents of each of which are incorporated herein by reference.

### FIELD OF THE INVENTION

The present invention relates to droplet quantity determination methods and measuring devices, and particularly relates to methods and measuring devices for determining droplet quantities using electromagnetic waves.

### BACKGROUND OF THE INVENTION

In recent years, droplets handled by dispensing burettes or the like have become extremely small in quantity. An extremely minute droplet in a quantity of approximately 0.1 to 10 μL is handled by a dispensing burette, for example. On the other hand, it has been difficult to precisely measure a quantity of such a minute droplet. As such, the quantity of a droplet dispensed by the dispensing burette cannot be precisely confirmed.

Meanwhile, Patent Document 1 cited below discloses a method for measuring characteristics of a measurement object such as powder or the like using electromagnetic waves. In the measuring method disclosed in Patent Document 1, a measurement object such as powder is disposed on a principal surface of an aperture-arranged structure in which a plurality of aperture sections are provided. In a specific embodiment disclosed in Patent Document 1, adipin as a measurement object is attached to the principal surface of the aperture-arranged structure. Then, electromagnetic waves are emitted toward the aperture-arranged structure so that the emitted electromagnetic waves are incident on the principal surface of the aperture-arranged structure at a slant angle. Due to the incident angle being slanted, a dip waveform is generated in a frequency characteristic of measurement values. A frequency, transmittance, and the like at which the above dip waveform is generated change due to presence of the measurement object. Based on this change, the quantity of the measurement object is detected.
Patent Document 1: Japanese Unexamined Patent Application Publication No. 2008-185552

### SUMMARY OF THE INVENTION

Patent Document 1 discloses a method for measuring characteristics of a powder object such as adipin using electromagnetic waves. However, Patent Document 1 only discloses that characteristics of a measurement object such as powder are measured using the above-mentioned electromagnetic waves, and makes no mention of determination of a minute droplet quantity.

It is an object of the present invention to provide droplet quantity determination methods and measuring devices by which determination of a minute droplet quantity, which has been difficult to determine, can be realized with ease and precision.

A droplet quantity determination method according to the present invention includes holding a droplet serving as a measurement target substance on a first principal surface of an aperture-arranged structure having the first principal surface and a second principal surface which opposes the first principal surface and also having a plurality of aperture sections which penetrate through the aperture-arranged structure from the first principal surface toward the second principal surface; emitting electromagnetic waves to the droplet held on the aperture-arranged structure, the electromagnetic waves being absorbed or reflected by the droplet; and determining a quantity of the droplet based on a change between reference electromagnetic waves emitted toward the aperture-arranged structure on which the droplet is not held and the electromagnetic waves emitted when the droplet is held thereon.

In a specific aspect of the droplet quantity determination method according to the present invention, the quantity of the droplet is determined in accordance with changes in transmittance and/or reflectance of the electromagnetic waves.

In another specific aspect of the droplet quantity determination method according to the present invention, the first principal surface of the aperture-arranged structure is modified so that the above-mentioned droplet is held with ease.

In still another specific aspect of the droplet quantity determination method according to the present invention, modification on the first principal surface of the aperture-arranged structure is carried out by providing a material layer having affinity for the droplet.

A droplet measuring device according to the present invention includes an aperture-arranged structure, an electromagnetic wave emitting unit, and a detection unit. The aperture-arranged structure has a first principal surface on which a droplet as a measurement target substance is held and a second principal surface that opposes the first principal surface, and a plurality of aperture sections which penetrate through the aperture-arranged structure from the first principal surface toward the second principal surface. The electromagnetic wave emitting unit emits electromagnetic waves to the first principal surface of the aperture-arranged structure. The detection unit detects an electromagnetic wave that is absorbed or reflected by the droplet and outputs an electric signal based on the detected electromagnetic waves.

It is preferable for the droplet measuring device according to the present invention to further include an analysis processing unit that is supplied with the electric signal outputted from the detection unit and determines a quantity of the droplet in accordance with a difference between the electric signal based on reference electromagnetic waves where the droplet is absent and the electric signal based on the electromagnetic waves of the droplet being held on the first principal surface.

In the droplet quantity determination method according to the present invention, the quantity of a droplet is determined based on a change in the electromagnetic waves between a case in which the droplet is held on the aperture-arranged structure and a case in which the droplet is not held thereon. This makes it possible to determine a minute droplet quantity with high precision.

### BRIEF DESCRIPTION OF THE DRAWINGS

FIG. 1 is a perspective view illustrating an aperture-arranged structure used in a droplet quantity determination method according to an embodiment of the present invention.

FIGS. 2(a) and 2(b) are a plan view and a front cross-sectional view, respectively, illustrating a structure in which an aperture-arranged structure is fixed to a jig in an embodiment of the present invention.

FIG. 3 is a front view illustrating an aperture-arranged structure used in a droplet quantity determination method in an embodiment of the present invention.

FIG. 4 is a schematic block diagram illustrating a measuring device used in a droplet quantity determination method according to an embodiment of the present invention.

FIG. 5 is a graph illustrating a change in transmittance in the case where a 2.0 μL droplet is held on an aperture-arranged structure in a working example of the present invention.

FIG. 6 is a graph illustrating a change in transmittance in the case where a 0.2 μL droplet is held on an aperture-arranged structure in a working example of the present invention.

FIG. 7 is a graph illustrating a change in transmittance in the case where a 0.5 μL droplet is held on an aperture-arranged structure in a working example of the present invention.

FIG. 8 is a graph illustrating a change in transmittance in the case where a 1.0 μL droplet is held on an aperture-arranged structure in a working example of the present invention.

FIG. 9 is a graph illustrating a change in transmittance in the case where a 1.5 μL droplet is held on an aperture-arranged structure in a working example of the present invention.

FIG. 10 is a graph illustrating a calibration curve prepared in a working example of the present invention.

FIG. 11 is a graph illustrating a relationship between a dropping quantity of liquid and a decreasing rate of transmittance in a case in which liquid is dispersed and dropped as a plurality of droplets and a case in which liquid is dropped as a single droplet.

FIG. 12 is a schematic diagram illustrating a surface shrinkage state of an aperture-arranged structure (a).

FIG. 13 is a schematic diagram illustrating a surface shrinkage state of an aperture-arranged structure (b).

FIG. 14 is a graph illustrating decreasing rates of infrared light transmittance of a water drop attaching portion compared to infrared light transmittance of the water drop attaching portion before a water drop is attached thereto in the aperture-arranged structure (a), the aperture-arranged structure (b), and an aperture-arranged structure (c), respectively.

### DETAILED DESCRIPTION OF THE PREFERRED EMBODIMENTS

Hereinafter, the present invention will be clarified through describing a specific embodiment of the invention with reference to the drawings.

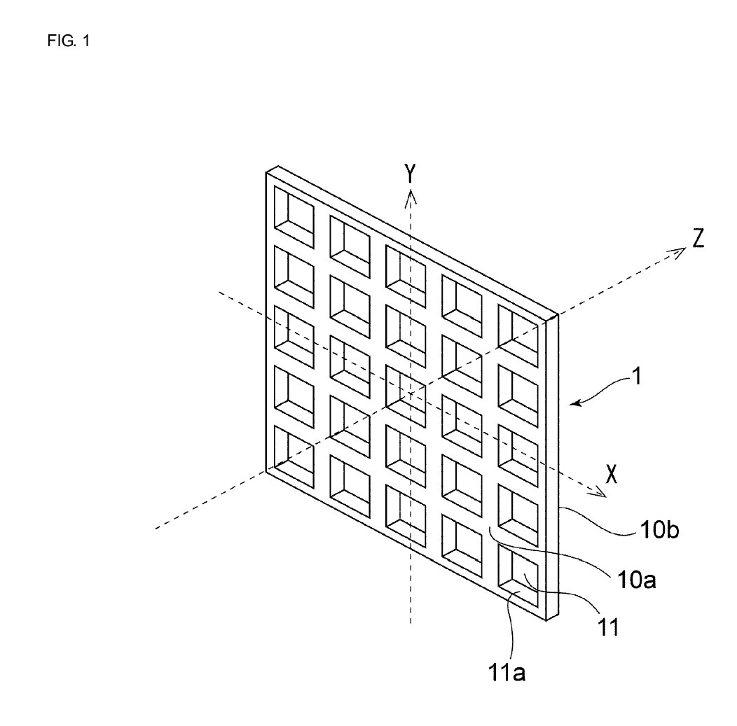

In a droplet quantity determination method of the present embodiment, an aperture-arranged structure 1 as shown in FIG. 1 is used. Although the shape of the aperture-arranged structure 1 is not limited to any specific one, the aperture-arranged structure 1 is formed in a rectangular plane shape. The aperture-arranged structure 1 includes a first principal surface 10a and a second principal surface 10b which is a principal surface on the opposite side. An aperture section 11 is so provided as to penetrate therethrough from the first principal surface 10a to the second principal surface 10b.

The aperture sections 11 are periodically disposed on the principal surface of the aperture-arranged structure 1 in at least one direction. Note that, however, all the aperture sections 11 are not necessarily needed to be disposed in a periodical manner, and some of them may be disposed in a non-periodical manner. Further, it is preferable for the aperture sections 11 to be disposed in a two-dimensional, periodical manner. In the present embodiment, the plurality of aperture sections 11 are disposed in matrix form. In other words, the plurality of aperture sections 11 are aligned and disposed in an X direction and a Y direction, respectively.

The plane shape of the aperture section 11 is considered to be square in the present embodiment. However, as will be described later, the shape of the aperture section 11 can be changed as needed.

Length of one side of an opening of the aperture section 11 should be determined in accordance with the size of a droplet, and it is preferable for the above length to be 0.15 to 150 μm, and more preferable to be 0.9 to 9 μm from the standpoint of measurement sensitivity. It is preferable for a pitch (lattice interval) of the aperture section 11 to be no less than one tenth and no more than 10 times a wavelength of the electromagnetic waves used for the measurement so as to make the electromagnetic waves easy to be dispersed. To be specific, the pitch is preferable to be 1.3 to 13 μm from the standpoint of measurement sensitivity.

It is preferable for the aperture-arranged structure 1 to be made of a material having low electric resistance. As such material, a metal, a semiconductor, or the like can be cited. It is more preferable to use a metal. As such metal, gold, silver, copper, iron, nickel, tungsten, an alloy of these metals, or the like can be cited.

A droplet is held on the first principal surface 10a of the aperture-arranged structure 1. In this case, it is desirable for the size of the aperture section 11 to be set so that the droplet will not pass therethrough. In general, when the droplet is held on the aperture-arranged structure 1, the posture of the first principal surface 10a and second principal surface 10b of the aperture-arranged structure 1 is maintained to be along the horizontal direction or at an angle which is slightly inclined relative to the horizontal direction. Thereafter, the droplet is dropped onto an upper surface side, for example, the first principal surface 10a side and held thereon.

In order to attach the droplet and keep a state in which the droplet is being held, it is desirable to dispose the first principal surface 10a of the aperture-arranged structure 1 along the horizontal direction, not along the vertical direction as shown in FIG. 1. However, the principal surface may be inclined relative to the horizontal direction to some extent.

In the case where the aperture-arranged structure 1 is disposed so that the first principal surface 10a faces the horizontal direction as described above, the droplet will drop downward from the aperture section 11 if the size of the aperture section 11 is too large in comparison with the droplet. Accordingly, as described before, it is desirable for the size of the aperture section 11 to be set so that the droplet will not pass therethrough.

It is to be noted that the droplet can also be held by surface tension between the droplet and the aperture-arranged structure 1. Accordingly, the size of the droplet may be slightly smaller than that of the aperture section 11 as long as the droplet can be held by the above surface tension. In other words, the droplet may be set slightly smaller in size than the aperture section 11 in accordance with the surface tension, viscosity, and the like of the droplet as long as the droplet will not drop downward from the aperture section 11.

As is clear from a working example to be described later, it is desirable for the droplet to be larger than a single aperture section 11, and the droplet may be so held as to extend across the plurality of aperture sections 11 and 11.

Further, the droplet may be held on the first principal surface 10a in a state of being attached to an inner side surface 11a of the aperture section 11 at the inside of the aperture section 11.

In the droplet quantity determination method of the present embodiment, a droplet is held on the first principal surface 10a of the aperture-arranged structure 1, and then electromagnetic waves, which are absorbed or reflected by the droplet being held, are emitted to the droplet being held. As such electromagnetic waves, electromagnetic waves in a terahertz band (1-200 THz) are preferably used.

A transmission or reflection characteristic of the electromagnetic waves in the aperture-arranged structure changes by an amount of the electromagnetic waves being absorbed or reflected by the droplet that is held on the principal surface of the aperture-arranged structure. Since the amount of change depends on the quantity of the droplet, the quantity of the droplet can be determined from the change in the transmission or reflection characteristic in the aperture-arranged structure.

In the droplet quantity determination method of the present embodiment, the quantity of the droplet is determined based on the change caused by the absorption or reflection of the electromagnetic waves by the droplet as described above. This makes it possible to determine a minute droplet quantity with high precision.

As disclosed in Patent Document 1 mentioned before, a method for measuring powder quantity or the like by emitting electromagnetic waves toward an aperture-arranged structure has been well-known. However, measurement of a minute droplet is not referred to in the description of a measuring method using electromagnetic waves disclosed in Patent Document 1. As such, the size of the aperture section is not defined in consideration of the size of the droplet. Accordingly, in the case of measuring a minute droplet, there arises a risk that the droplet passes through the aperture section. In addition, in the existing measuring method as disclosed in Patent Document 1, a film, a membrane filer, or the like is laminated on the aperture-arranged structure, and a measurement object held on the film, the membrane filter, or the like is measured. As such, the film, the membrane filter, or the like adheres to the aperture-arranged structure. As a result, there is a problem that sensitivity is lowered due to a material of the film, the membrane filer, or the like having an electromagnetic absorption capability itself. Further, in the case where an organic film, an organic membrane filer, or the like is used, the surface has water repellency. This raises a problem that an aqueous droplet or the like is difficult to be held. Therefore, the existing measuring method using electromagnetic waves and an aperture-arranged structure as disclosed in Patent Document 1 cannot determine a minute droplet quantity with high precision.

In contrast, in the present embodiment, because the size of the aperture section in the aperture-arranged structure is set so that the droplet is unlikely to pass therethrough, it is possible to determine the quantity of the droplet with high precision based on the change in the electromagnetic waves.

Next, a specific working example of the droplet quantity determination method of the present invention will be described so as to make it clear that a droplet quantity can be precisely determined.

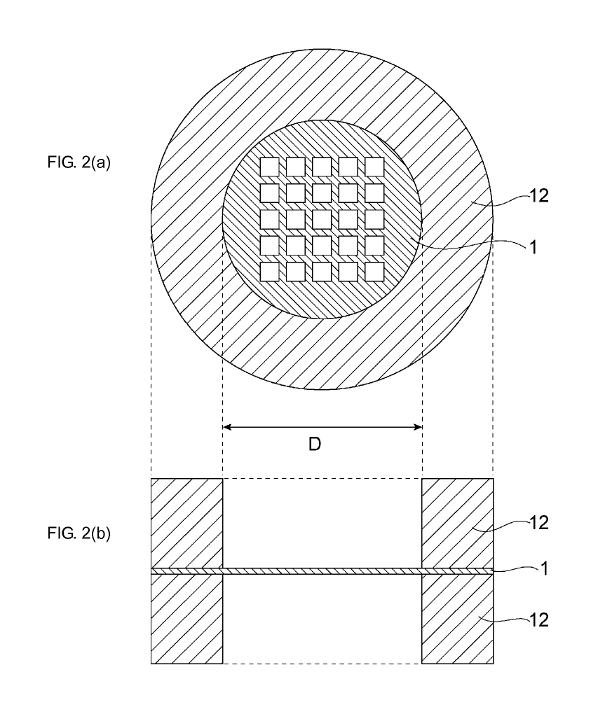

In the present working example, the aperture-arranged structure 1 was sandwiched between jigs 12 and 12 as shown in FIGS. 2(a) and 2(b). The jigs 12 and 12 are each a jig formed in an approximately cylinder shape. An inner diameter of the jig 12 is taken as “D”.

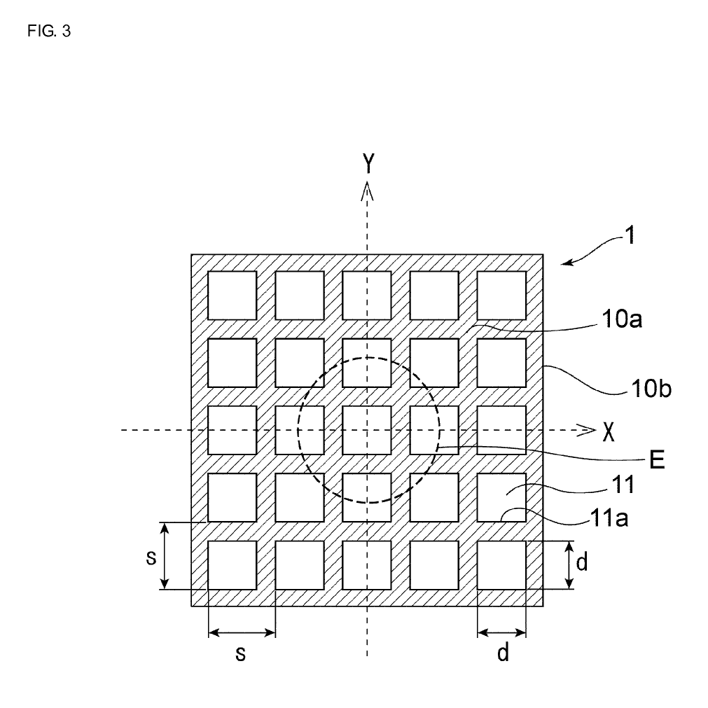

A main portion of the aperture-arranged structure 1 is schematically illustrated in FIG. 3, where a pitch of the aperture section 11 is taken as “s” and a length of one side of the aperture section 11 is taken as “d” in the aperture-arranged structure 1. In FIG. 3, a droplet held as a measurement object is schematically indicated by a broken line E.

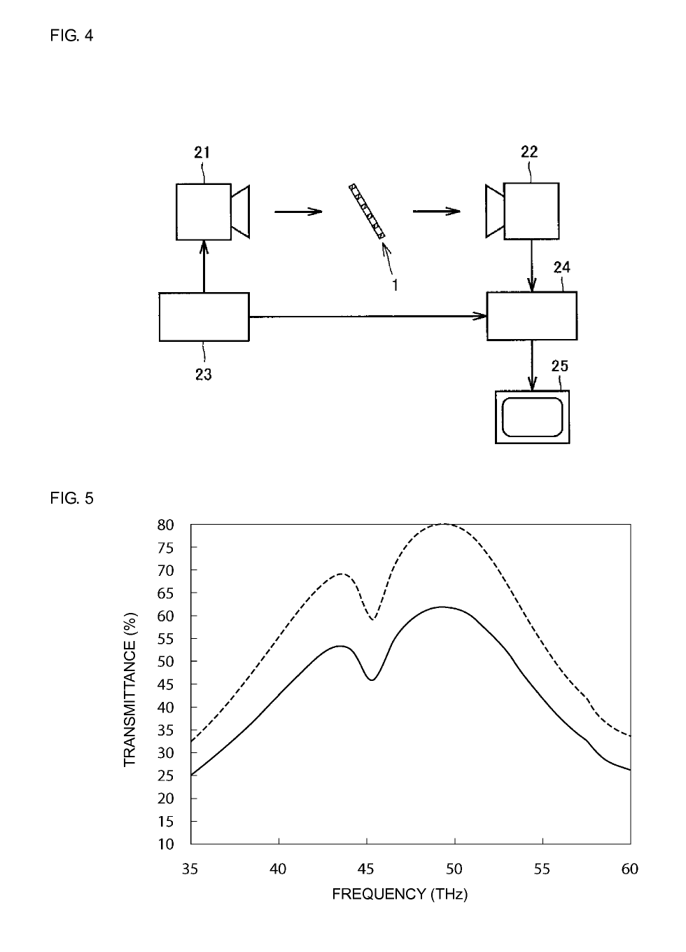

A measuring device illustrated by a schematic block diagram in FIG. 4 was used. This measuring device includes an emitting unit 21 configured to emit electromagnetic waves and a detection unit 22 configured to detect electromagnetic waves being scattered at the aperture-arranged structure 1. Further, an emission control unit 23 configured to control operations of the emitting unit 21 and an analysis processing unit 24 configured to process a detection result obtained by the detection unit 22 are provided. A display unit 25 configured to display an analysis result is connected to the analysis processing unit 24.

Note that in the present embodiment, electromagnetic waves which are scattered at the aperture-arranged structure 1 are detected, as described above. In this case, the term “scatter” means a broad concept including transmission, reflection, and the like. It is preferable to mean transmission and reflection, and more preferable to mean transmission in a zero-order direction, reflection in a zero-order direction, and the like.

In general, in the case where a grating space of a diffraction grating (corresponds to a space of an aperture section in the present specification) is taken as “d”, an incident angle is takes as “i”, a diffraction angle is taken as θ, and a wave length is taken as λ, a spectrum diffracted by the diffraction grating can be represented as follows.

d(sin i−sin θ)=nλ Formula(1)

Here, “zero-order” in the expression of “zero-order direction” indicates a case in which n is 0 in Formula (1). Because neither d nor λ can be 0, n=0 holds only when (sin i−sin θ) equals 0. Accordingly, the expression of “zero-order direction” corresponds to a state in which the incident angle is equal to the diffraction angle, in other words, means a direction in which the electromagnetic waves travel with the travelling direction unchanged.

In the measuring method of the present embodiment, electromagnetic waves are emitted from the emitting unit 21 toward the aperture-arranged structure 1 under the control of the emission control unit 23. Electromagnetic waves that have passed through the aperture-arranged structure 1 are detected by the detection unit 22. In the detection unit 22, the detected electromagnetic waves are converted to an electric signal and supplied to the analysis processing unit 24. The analysis processing unit 24 supplies this electric signal to the display unit 25. The display unit 25 displays a frequency characteristic of transmittance based on the electric signal.

It is preferable that, as will be described later, the analysis processing unit 24 be configured such that a signal in accordance with the quantity of a droplet is calculated based on a change in transmittance between a case in which the droplet is present and a case in which the droplet is absent in the aperture-arranged structure and consequently an electric signal in accordance with the quantity of the droplet is outputted.

The aperture-arranged structure 1 was prepared where the pitch “s” shown in FIG. 3 was 5.2 μm, the length “d” of one side of an opening of the aperture section 11 also shown in FIG. 3 was 3.6 μm, and thickness thereof was 1.2 μm. The material of the aperture-arranged structure 1 was nickel. The respective inner diameters D of the jigs 12 and 12 were set to 6 mm, outer diameters thereof were set to 14 mm, and thicknesses thereof were set to 1.5 mm.

First, infrared light as electromagnetic waves was emitted toward the aperture-arranged structure 1 sandwiched between the jigs 12 and 12 so as to measure transmittance. In the measurement, the infrared light was emitted to a circular region whose diameter was 5 mm centered about the aperture-arranged structure 1. Note that in the measurement of transmittance thereafter carried out, the infrared light was also emitted to a circular region whose diameter was 5 mm centered about the aperture-arranged structure 1.

Next, a 2.0 μL water drop was dropped onto the center of the aperture-arranged structure 1. Thereafter, the infrared light was emitted in the same manner as described above so as to measure the transmittance.

A broken line in FIG. 5 is a graph indicating a transmittance-frequency characteristic in the aperture-arranged structure 1 before the above water drop was dropped. A solid line in FIG. 5 indicates a transmittance-frequency characteristic obtained by the measurement after the 2.0 μL water drop was dropped.

As is clear from FIG. 5, in the case where infrared light as electromagnetic waves is emitted toward the aperture-arranged structure 1, a frequency characteristic in which a dip portion is generated at a frequency in the vicinity of approximately 45.1 THz is obtained. It can be understood that, in the case where a water drop is held, the electromagnetic waves are reflected or absorbed by the water drop so that the transmittance in the aperture-arranged structure is lowered.

In other words, it can be understood that electromagnetic wave transmittance changes when a water drop is held on the aperture-arranged structure 1.

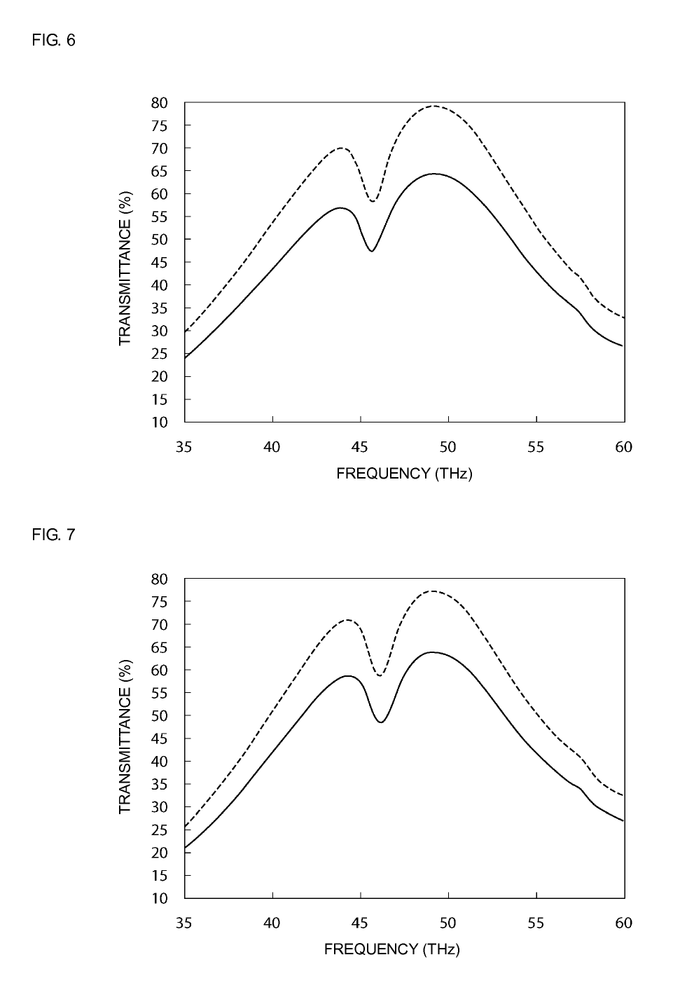

Subsequently, transmittance was measured in the same manner as described above, but in this case, the quantity of a water drop was set to 0.2 μL. A broken line in FIG. 6 indicates a transmittance-frequency characteristic before the water drop was dropped, while a solid line indicates a transmittance-frequency characteristic after the 0.2 μL water drop was held. As is clear from FIG. 6, also in the case of the 0.2 μL water drop being attached, it can be understood that the transmittance is lowered due to the water drop being held. Further, when FIGS. 5 and 6 are compared with each other, it can be understood that a decreasing rate of transmittance in FIG. 6 where the water drop being held is smaller in quantity is smaller than that in FIG. 5. Although the decreasing rate of transmittance may be measured at any frequency position, a change rate at the bottom of the aforementioned dip portion was measured in the present working example.

Furthermore, the transmittance-frequency characteristics before the water-drop dropping each indicated by a broken line in FIG. 5 and FIG. 6, are slightly different from each other. This is because respective initial states of the aperture-arranged structure 1 are slightly different from each other. Note that, however, by measuring the transmittance-frequency characteristics before and after the attachment of the water drop in the manner described above, a change in the transmittance due to the water drop being actually attached can be more precisely measured. As such, each time when each droplet quantity is determined, it is desirable to measure the transmittance before the droplet attachment and the transmittance after the droplet attachment and obtain a change in the transmittance.

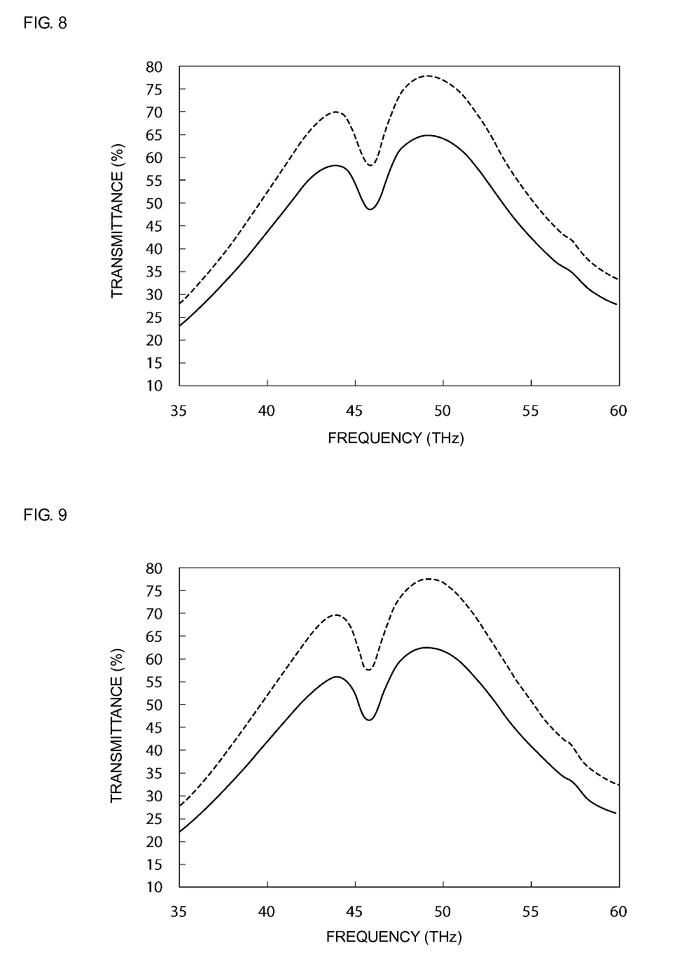

FIGS. 7 through 9 are graphs indicating changes of the transmittance-frequency characteristics obtained in the same manner as described above except that quantities of the attached droplets were 0.5 μL, 1.0 μL, and 1.5 μL, respectively. Also in FIGS. 7 through 9, broken lines represent the transmittance-frequency characteristics in initial states before the droplet attachment, while solid lines represent the transmittance-frequency characteristics after the droplet attachment.

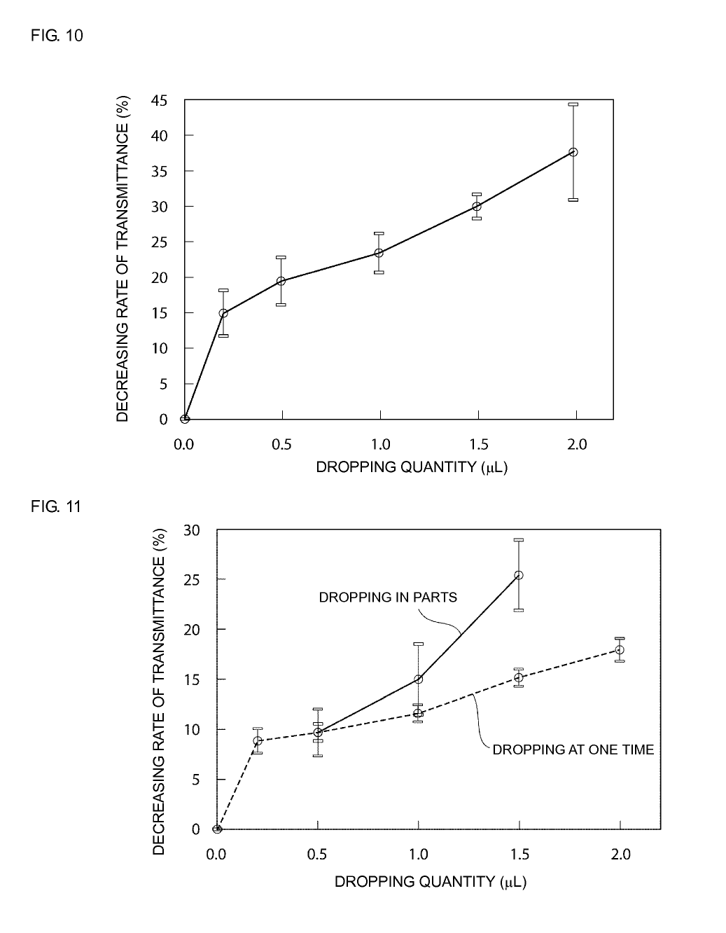

As is clear by comparing FIGS. 7 through 9 with FIGS. 5 and 6, it can be understood that the decreasing rates of transmittance differ depending on the quantities of the attached water drops as discussed before. Based on the results shown in FIGS. 5 through 9, a relationship between the water-drop dropping quantity and the decreasing rate of transmittance was obtained. The result obtained is shown in FIG. 10. As is clear from FIG. 10, it is understood that a correlation between the water-drop dropping quantity, or the quantity of the water drop held on the aperture-arranged structure 1 and the decreasing rate of transmittance can be obtained. In other words, it is understood that the quantity of a water drop in an unknown volume can be determined, taking a solid line shown in FIG. 10 as a calibration line, from the decreasing rate of transmittance.

In the present working example, it is understood that a minute water drop in a quantity of 0.2 to 2.0 μL can be determined with high precision because the size of the aperture-section 11 is defined as discussed before.

Depending on the quantity of a droplet, it is preferable that a droplet be dispersed and dropped in a plurality of droplets. This operation will be described hereinafter with reference to FIG. 11. A broken line in FIG. 11 is equivalent to the calibration curve in FIG. 10. Meanwhile, a solid line in FIG. 11 indicates a result of operation in which when a 0.5 μL water drop, a 1.0 μL water drop, and a 1.5 μL water drop were respectively dropped onto the aperture-arranged structure 1, each of the above water drops was dispersed in water drops each having a quantity of 0.5 μL and held thereon. In other words, in the case of a dropping quantity of 1.0 μL for the solid line, a 0.5 μL water drop was dropped twice on the aperture-arranged structure 1 in a dispersing manner. In the case of a dropping quantity of 1.5 μL, three droplets each having a quantity of around 0.5 μL were dropped onto the aperture-arranged structure 1 in a dispersing manner.

As is clear from FIG. 11, it can be understood that, in the case where a water drop is dispersed and dropped in water drops each having a quantity of 0.5 μL as described above, the decreasing rate of transmittance is larger than a calibration curve indicated by the broken line. Accordingly, it is preferable for a droplet to be dispersed and dropped in a plurality of droplets, which makes it possible to understand that measurement sensitivity can be raised.

The droplet quantity determination method of the present invention is not limited to the determination of water drop quantities mentioned above, and quantities of various solutions, water dispersions, organic solutions, or organic dispersants may be determined. In addition, substances dissolved or dispersed in water or organic solvents are not limited to any specific one, and arbitrary substances such as biochemical substances, inorganic compounds, organic compounds, and so on can be cited.

It is desirable to modify at least the first principal surface 10a of the aperture-arranged structure 1 so as to hold a droplet with ease. Methods for the modification are not limited to any specific one. For example, a method that a material to which a liquid can be coupled or adsorbed is provided on the first principal surface can be cited. It is desirable to provide a material layer having affinity for droplets on the first principal surface. For example, in the case where a droplet is a solvent having no polarity such as hexane or a solvent having a low polarity, it is desirable to modify the surface with molecules having a long alkyl chain and make the surface hydrophobic. This will be explained below.

Aperture-arranged structures (a), (b), and (c) as follows were prepared.

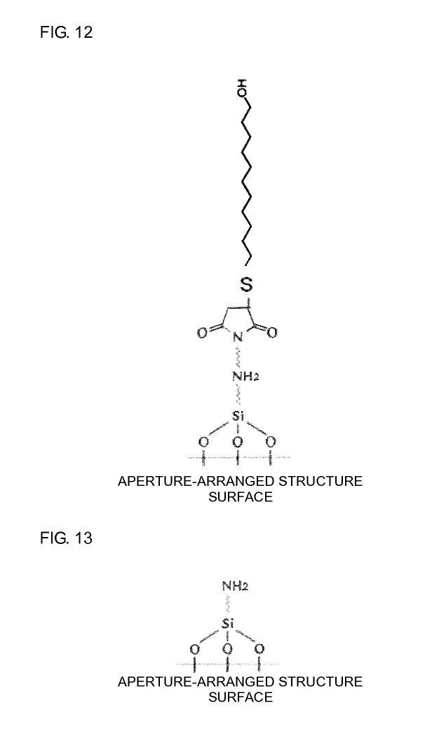

(a) A structure that the surface of the aperture-arranged structure shown in FIG. 3 is modified by a material having an OH group at a terminal as shown in FIG. 12.

(b) A structure such that the surface of the aperture-arranged structure shown in FIG. 3 is modified by a material having an amino group at a terminal as shown in FIG. 13.

(c) The aperture-arranged structure shown in FIG. 3, on which surface modification has not been carried out.

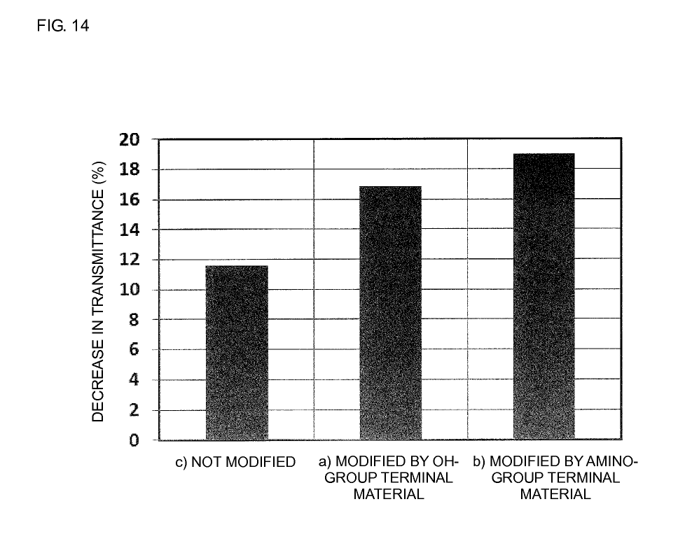

Infrared light was emitted toward the aperture-arranged structures (a), (b), and (c) to measure transmittance. Next, infrared light was emitted toward the aperture-arranged structures (a), (b), and (c) to measure transmittance after a 1 μL water drop was attached on the aperture-arranged structures (a), (b), and (c), respectively. Decreasing rates of infrared light transmittance after the water drop attachment compared to infrared light transmittance before the water drop attachment in each aperture-arranged structure, are shown in FIG. 14.

As shown in FIG. 14, in the case where surface modification is carried out using the OH-group terminal material as well as the case where surface modification is carried out using the amino-group terminal material, the decreasing rate of infrared light transmittance, or the amount of change in infrared light transmittance is large in comparison with the case where surface modification is not carried out. This means that the precision of quantity determination is improved by the modification.

Combinations of material layers having affinity for the above-described droplets are also not limited to any specific one.

Because the invention makes use of transmission or reflection of electromagnetic waves by droplets, as described thus far, it is unnecessary to perform labeling or the like on a droplet as a measurement object and a substance dissolved or dispersed in the droplet. As such, a minute droplet quantity can be measured with ease and high precision.

The shape of the aperture section 11 is not limited to a square as in the above embodiment. The aperture-section 11 can take any preferable shape such as a rectangle, a circle, an isosceles trapezoid, or the like aside from a square. Further, the aperture sections are not necessarily required to be arranged in matrix form along the X and Y directions. The arrangement of the aperture sections is also not limited to any specific one as long as they are periodically arranged. Furthermore, some of the aperture sections may be periodically arranged and the rest of them may be non-periodically arranged.

It is preferable for the aperture-arranged structure 1 to be a quasi-periodic structure, a periodic structure, or the like. The quasi-periodic structure is a structure that does not have translation symmetry but maintains orderliness in its arrangement. As a quasi-periodic structure, for example, a Fibonacci structure as a one-dimensional quasi-periodic structure and a Penrose structure as a two-dimensional quasi-periodic structure can be cited. The periodic structure is a structure that has spatial symmetry as represented by translation symmetry and is classified into a one-dimensional periodic structure, a two-dimensional periodic structure, and a three-dimensional periodic structure in accordance with the dimension of symmetry. As one-dimensional periodic structures, for example, a wire grid structure, a one-dimensional diffraction grating, and the like can be cited. As two-dimensional periodic structures, for example, a mesh filter, a two-dimensional diffraction grating, and the like can be cited. Of these periodic structures, the two-dimensional periodic structure is preferably used.

A dimension of an aperture section 2c in the aperture-arranged structure 1 may be appropriately designed in accordance with measurement methods, characteristics of a material of the aperture-arranged structure formed in a plate shape, a frequency of electromagnetic waves to be used, and the like.

Because an average thickness of the aperture-arranged structure 1 is appropriately designed in accordance with measurement methods, characteristics of a material of the aperture-arranged structure formed in a plate shape, a frequency of electromagnetic waves to be used, and the like, it is difficult to generalize the range of thickness. However, in the case of detecting forward scattering electromagnetic waves, it is preferable for the thickness to be no more than several times the wave length of electromagnetic waves used in the measurement.

It is preferable for the thickness of the aperture-arranged structure 1 to be no more than five times the wave length of electromagnetic waves used in the measurement. By doing so, intensity of forward scattering electromagnetic waves is strengthened so that the signal is detected with ease.

The overall dimensions of the aperture-arranged structure 1 are not limited to any specific ones, and are determined in accordance with an area of a beam spot of the electromagnetic waves to be emitted.

Methods for attaching a measurement object to the aperture-arranged structure 1 are not limited to any specific one. Chemical coupling or the like may be formed between a surface of the aperture-arranged structure 1 and the measurement object. Alternatively, in the case where the measurement object has adhesiveness or the like, the measurement object may be allowed to adhere to the surface of the aperture-arranged structure 1 by making use of the adhesiveness so as to be attached to the surface thereof.

It is preferable that at least a part of the surface of the aperture-arranged structure 1 be electrically conductive. It is preferable that at least a part of the surface be configured of a material that exhibits the above conductivity, that is, configured of a conductor. The conductor mentioned above is not limited to any specific conductor, and an appropriate metal, a semiconductor, or the like can be used.

As discussed above, because the aperture-arranged structure 1 can further strengthen the intensity of scattering electromagnetic waves, it is preferable that at least a part thereof be configured of a conductor. The whole aperture-arranged structure 1 may be configured of a conductor. It is preferable to use, among conductors, a conductor that can be coupled to various functional groups such as a hydroxyl group, an amino group, and the like. To be more specific, Au, Ag, Cu, Ni, Cr, Si, and Ge can be cited; among these, Ni and Au can be preferably cited. In particular, Ni is useful in a point that it can be coupled to a thiol group, an alkoxysilane group, and the like.

### REFERENCE SIGNS LIST

1 aperture-arranged structure
2c aperture section
10a first principal surface
10b second principal surface
11 aperture section
11a inner side surface
12 jig
21 emitting unit
22 detection unit
23 emission control unit
24 analysis processing unit
25 display unit

1. A droplet quantity determination method comprising:
emitting an electromagnetic wave to a droplet as a measurement target substance on a first principal surface of an aperture-arranged structure having the first principal surface and a second principal surface which opposes the first principal surface and also having a plurality of aperture sections which penetrate through the aperture-arranged structure from the first principal surface toward the second principal surface such that the electromagnetic wave is absorbed or reflected by the droplet; and
determining a quantity of the droplet based on a change between a reference electromagnetic wave emitted toward the aperture-arranged structure on which the droplet is not held and a the electromagnetic wave being emitted when the droplet is held on the aperture-arranged structure.

2. The droplet quantity determination method according to claim 1,
wherein the quantity of the droplet is determined in accordance with changes in transmittance and/or reflectance characteristics of the electromagnetic wave.

3. The droplet quantity determination method according to claim 2,
wherein the first principal surface of the aperture-arranged structure is modified to hold the droplet.

4. The droplet quantity determination method according to claim 3,
wherein modification of the first principal surface of the aperture-arranged structure is providing a material layer having affinity for the droplet.

5. The droplet quantity determination method according to claim 1,
wherein the first principal surface of the aperture-arranged structure is modified to hold the droplet.

6. The droplet quantity determination method according to claim 5,
wherein modification of the first principal surface of the aperture-arranged structure is providing a material layer having affinity for the droplet.

7. The droplet quantity determination method according to claim 1,
wherein a size of the plurality of aperture sections is set such that the droplet does not pass therethrough.

8. A droplet measuring device comprising:
an aperture-arranged structure that includes a first principal surface on which a droplet as a measurement target substance is held, a second principal surface opposing the first principal surface, and a plurality of aperture sections which penetrate through the aperture-arranged structure from the first principal surface toward the second principal surface;
an electromagnetic wave emitting unit that emits electromagnetic waves to the first principal surface of the aperture-arranged structure; and
a detection unit that detects an electromagnetic wave that is absorbed or reflected by the droplet in the aperture-arranged structure and converts the detected electromagnetic wave to an electric signal.

9. The droplet measuring device according to claim 8, further comprising:
an analysis processing unit that is supplied with the electric signal from the detection unit and determines a quantity of the droplet based on a change in the electric signal between a reference electromagnetic wave emitted toward the aperture-arranged structure on which the droplet is not held and the electromagnetic wave emitted when the droplet is held on the aperture-arranged structure.

10. The droplet measuring device according to claim 9,
wherein the first principal surface of the aperture-arranged structure is modified to hold the droplet.

11. The droplet measuring device according to claim 10,
wherein modification is a material layer having affinity for the droplet.

12. The droplet measuring device according to claim 8,
wherein the first principal surface of the aperture-arranged structure is modified to hold the droplet.

13. The droplet measuring device according to claim 12,
wherein modification is a material layer having affinity for the droplet.

14. The droplet measuring device according to claim 8,
wherein the plurality of aperture sections have a size that do not allow the droplet to pass therethrough.
